(19) United States
(12) Patent Application Publication
(10) Pub. No.: US 2008/0199596 A1
(43) Pub. Date: Aug. 21, 2008

(54) FLUID DISPENSE SYSTEM

(75) Inventor: Seiji Nakagawa, Oita-pref (JP)

Correspondence Address: BANNER & WITCOFF, LTD., 1100 13th STREET, N.W., SUITE 1200, WASHINGTON, DC, 20005-4051, US

(73) Assignee: TOSHIBA AMERICA ELECTRONIC COMPONENTS, INC., Irvine, CA (US)

(21) Appl. No.: 11/677,240

(22) Filed: Feb. 21, 2007

(51) Int. Cl. B05D 1/02

(52) U.S. Cl. 427/8; 118/313; 118/712; 427/421.1

(57) ABSTRACT

A system and method for dispensing fluid onto a surface during a manufacturing process. A fluid storage container holds a chemical, such as resist, used in a semiconductor lithography process. When not dispensing the chemical over the surface of a wafer, a pump and nozzle dispense the chemical into a dedicated dispense receptacle. A drain and pump may return the contents of the dispense receptacle to the fluid storage container for reuse.

### BACKGROUND

In semiconductor manufacturing, microlithography is used to form integrated circuits on a semiconductor wafer. During this lithographic process, a form of radiant energy, such as ultraviolet light, is passed through a mask, or stencil, and is projected onto the semiconductor wafer. The mask contains opaque and transparent regions formed in a desired pattern. A grating pattern, for instance, may be used to define parallel spaced conducting lines on a semiconductor wafer. A layer of chemicals that react to the ultraviolet light can be applied to the surface of the wafer. The ultraviolet light exposes the pattern on a layer of chemicals formed on the wafer. The pattern can then be used during a subsequent semiconductor fabrication process such as ion implantation or etching.

Chemicals may be applied to the surface of the semiconductor wafer before or after the projection of the light onto the wafer, and many different types of chemicals may be used throughout the manufacturing process. The various chemicals are commonly applied to the wafer with nozzles designed and positioned to spread the chemical evenly across the wafer surface. When a predetermined amount of a chemical has been dispensed onto the wafer surface, the flow of the chemical through the nozzle is shut off until another wafer is ready to receive the chemical. While the nozzles are not dispensing chemicals onto a wafer surface, it is desirable to prevent particles of the chemicals from drying and solidifying at the nozzle tip. Such particles can accumulate and disrupt the accurate dispensing of the chemical onto the wafer.

FIG. 1 is a diagram of a conventional system for reducing particle accumulation at the dispense nozzles in a semiconductor lithography process. Two different liquid chemicals 117 and 118 used in the semiconductor fabrication are stored in containers 102 and 103. The fluid 117 from container 102 is pumped through a filter 106, to a nozzle 108, by a pump 104. Similarly, the fluid 118 from container 103 is pumped through a filter 107 and into nozzle 109 with a pump 105. While nozzles 108 and 109 will be used at various times throughout the lithography process to dispense chemicals onto a semiconductor wafer 120, they are shown in FIG. 1 during a latent period during the process, when no semiconductor wafer is ready for a chemical dispense.

The nozzles 108 and 109 of the dispense system are positioned above a single shared nozzle bath 110. To reduce particle solidification in these nozzles, a solvent 112 is connected and a solvent flow 114 is directed into the nozzle bath 110. The vapors from the solvent flow 114 permeate the air surrounding the nozzles 108 and 109 and are intended to prevent particles from accumulating at the tip of the nozzles 108 and 109. Additionally, an occasional “dummy dispense” of the chemicals into nozzle bath 110 from nozzles 108 and 109 is performed to flush particles out of the nozzles 108 and 109.

Thus, the nozzle bath 110 will be of a mixture of the substance dispensed by nozzle 108, the substance dispense by nozzle 109, and the solvent 112. The resulting mixture is unusable and is discarded through a drain 116. Thus, every dummy dispense of a chemical from the nozzles 108 and 109 constitutes waste, potentially of a very expensive chemical. Resist, for example, may cost up to $10,000 per gallon. Thus, even an occasional dummy dispense results in significant loss. Additionally, the above-described method is not very effective at eliminating particle solidification and accumulation at the tip of the nozzles 108 and 109, resulting in imperfections during the subsequent dispensations of the chemicals onto a semiconductor wafer. Thus, there remains a need for an improved method to effectively reduce or even prevent particle solidification and accumulation at the dispense nozzles used in semiconductor lithography.

### SUMMARY

In light of the foregoing background, aspects of the present disclosure may reduce particle accumulation at dispense nozzles used in semiconductor lithography. In one aspect of the present disclosure, a fluid, such as the chemical resist used in semiconductor lithography, is pumped from a resist container to a nozzle in preparation for dispensing onto a surface. The fluid is dispensed from the nozzle into a dedicated dummy dispense receptacle, from which the fluid may be collected and pumped back into its original container for reuse. When the fluid is needed for dispensing onto a surface, for example, a wafer surface as part of a semiconductor lithography process, the dummy dispense into the receptacle is stopped and the nozzle is positioned over the wafer surface. After dispensing onto the wafer surface, the nozzle is positioned back over the dummy dispense receptacle to resume the dummy dispense.

According to another aspect of the present disclosure, a second fluid may be dispensed into a second dedicated dummy dispense receptacle. The fluid, for example, ARC used in semiconductor lithography, is pumped from an ARC container to a nozzle for dispensing the fluid onto the surface of a semiconductor wafer. While not being dispensed over the wafer surface, the ARC is dispensed from the nozzle into a second dummy dispense receptacle dedicated to collecting ARC and returning it back to the ARC container. These dedicated dummy dispense receptacles are kept separate and independent, to prevent to the mixing of different chemicals, thereby permitting the reuse of each chemical. In yet another aspect of the present disclosure, multiple nozzles which dispense the same chemical are channeled to dummy dispense into the same dummy dispense receptacle.

According to another aspect of the present disclosure, the use of solvent in a dummy dispense receptacle may be unnecessary to reduce particle solidification at the nozzle tip. A dummy dispense from the nozzle into the dedicated dummy dispense receptacle may reduce particle solidification without requiring a solvent to breakup particles at the nozzle tip. Further, since a dedicated dummy dispense receptacle may not contain either solvent or a mixed combination of chemicals, such a receptacle may allow the chemical to be reused, thus avoiding the significant cost of additional chemicals and chemical waste disposal.

These and other aspects of the disclosure will be apparent upon consideration of the following detailed description of illustrative embodiments.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram showing a conventional fluid dispense system for semiconductor lithography;

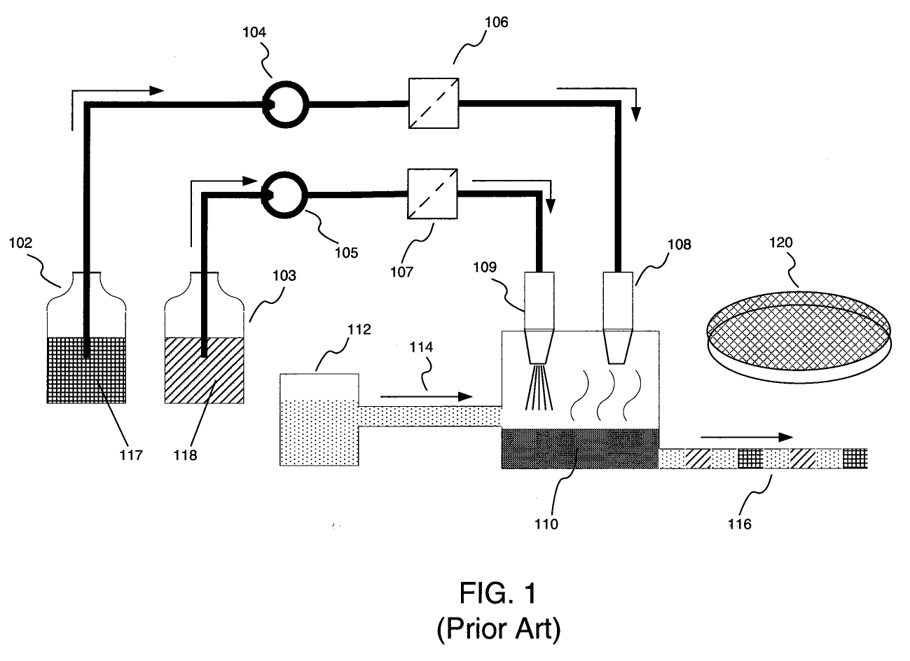

FIG. 2 is a schematic block diagram showing an illustrative dispense system for semiconductor lithography, in accordance with an embodiment of the present disclosure;

FIG. 3 is a flowchart showing illustrative steps for performing a single fluid dispense from a nozzle, in accordance with an embodiment of the present disclosure; and

FIG. 4 is a schematic block diagram showing an illustrative configuration of nozzles and dummy dispense receptacles, in accordance with an embodiment of the present disclosure.

### DETAILED DESCRIPTION OF ILLUSTRATIVE EMBODIMENTS

Illustrative embodiments will now be described more fully with reference to the accompanying drawings. The embodiments set forth herein should not be viewed as limiting; rather, these embodiments are provided merely as examples of the concepts described herein.

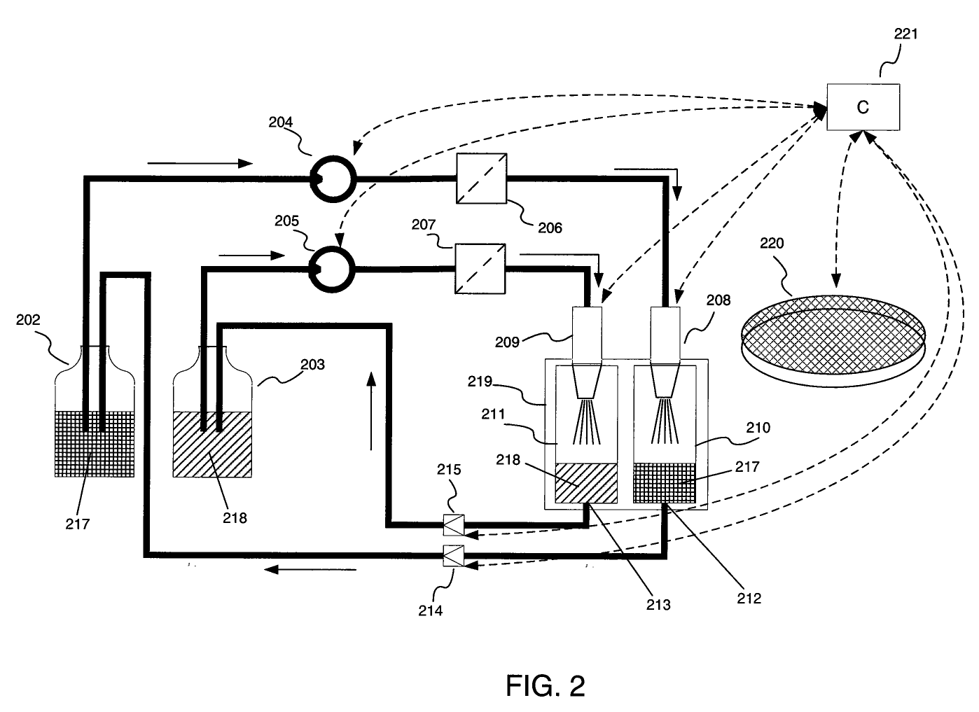

Referring to the FIG. 2, a schematic diagram is shown for an illustrative dispense system. In FIG. 2, a chemical 217 used in semiconductor fabrication may be stored in a container 202. For example, the chemical 217 may be resist, a light-sensitive material commonly used in semiconductor lithography processes. When applied to a surface, certain types of resist exposed to light become relatively soluble (positive resist), while other types of resist become relatively insoluble (negative resist) to a photoresist developer subsequently applied to the same surface. There are many variations of both positive and negative resist, and multiple resist variations are commonly used during a single lithography. Anti-reflective coating (ARC) substances are also commonly used in such semiconductor fabrication. ARC's are polymer based liquids used to control the light exposure to the silicon wafer during the lithography, and to effectively flatten the uneven topography of the wafer surface during the process. While the illustrative embodiments will be described as dispensing resist and ARC, the present disclosure is not limited to such uses. For example, solvents and etching chemicals may be applied to a wafer surface using the embodiments described herein.

In FIG. 2, the chemical 217, resist in this example, is pumped from container 202 to a nozzle 208 using a pump 204. Similarly, ARC 218 is pumped from a container 203 to a nozzle 209 using a pump 205. Source containers 202 and 203 may be any open or closed container configured to hold the respective chemicals 217 and 218. In certain embodiments, the pumps 204 and 205 are high-accuracy pumps. Such high-accuracy pumps are commonly preferred in semiconductor lithography for better control over the amount and distribution of the chemicals 217 and 218 onto the wafer surface. Additionally, filters 206 and 207 may be disposed between the containers 202 and 203 and their respective nozzles 208 and 209, to remove impurities or particles from the chemicals before they are dispensed onto the surface. The nozzles 208 and 209 are used in the semiconductor fabrication process to apply chemicals 217 and 218, resist and ARC, for example, to a surface, such as a wafer 220 of semiconductor chips. The nozzles 208 and 209 may be meticulously designed and manufactured to ensure an accurate application of the chemicals, as is well known in the art. As discussed above, any drips or blotches during the dispensing process, or the presence of any solid particles in the chemicals 217 and 218 or in the nozzles 208 and 209 is undesirable, and may negatively affect the manufacturing process.

In FIG. 2, pumps 204 and 205 and filters 206 and 207 are part of the separate fluid transport paths connecting the chemical containers 202 and 203 to their respective nozzles 208 and 209. In other illustrative embodiments, these fluid transport paths may not use a filter or a pump, but may be any coupling of components that allows the fluids 217 and 218 to be transported to the nozzles 208 and 209.

In FIG. 2, the nozzles 208 and 209 are shown during a latent state of the semiconductor fabrication process. That is, the nozzles 208 and 209 are not presently dispensing their resist 217 or ARC 218 onto the wafer surface 220. Nozzles 208 and 209 may be in between dispensations, awaiting the next lithography stage where one or both of the nozzles 208 and 209 will dispense chemicals 217 and 218 onto wafer 220. Note that nozzles 208 and 209 may operate independently of each other, they need not dispense onto the same surface and they need not dispense at the same time.

While awaiting a dispensing task, the nozzle 208 may be suspended over a dummy dispense receptacle 210, while nozzle 209 may be suspended over a separate dummy dispense receptacle 211. The dummy dispense receptacles may be, for example, nozzle baths similar to those commonly used in semiconductor lithography, but dedicated and without the need for a separate solvent inlet. A dummy dispense receptacle may also be a simple reservoir which collects a pool of fluid beneath the nozzle. In further embodiments, a dummy dispense receptacle may not be nozzle bath or reservoir, but may be, for example, a funnel or a pipe, to immediately convey the fluid upon its arrival at the receptacle, rather than holding it.

Each dummy dispense receptacle may be associated with only one of the dispense nozzles. Additional nozzles and dummy dispense receptacles may also be used, each receptacle dedicated to a particular nozzle. For example, a third nozzle used in this same manufacturing process, fed from a different chemical container, may have its own separate dummy dispense receptacle. Thus, the chemicals in the dummy dispense receptacle 210 are kept separate from the different chemicals in the dummy dispense receptacle 211. A dummy dispense receptacle housing 219 may be a single structure enclosing the dummy dispense receptacles 210 and 211. Drains 212 and 213 empty the contents of the dummy dispense receptacles 210 and 211, respectively. Pumps 214 and 215 may transport the respective chemicals 217 and 218, out of dummy dispense receptacles 210 and 211, through drains 212 and 213, and return the chemicals to their respective containers 202 and 203 for reuse.

In the illustrative embodiment shown in FIG. 2, separate fluid transport paths return the chemicals 217 and 218 to the containers 202 and 203 with pumps 214 or 215. However, these returning fluid transport paths, or feedback paths, may be combined with the fluid transport paths that convey the chemicals 217 and 218 to the nozzles 208 and 209. In such embodiments, the containers 202 and 203 may be cut out of the feedback paths, and the separate fluid transport paths may be combined into single round-trip paths. For example, the chemicals 217 and 218 may be pumped directly from dummy dispense receptacles 210 and 211, to nozzles 208 and 209, by the pumps 204 and 205. Thus, the previously separate fluid transport paths are conceptually a single feedback path for each chemical. In either case, the chemicals collected by the dummy dispense receptacles 210 and 211 may be transported back through one or more the fluid transport paths, eventually returning to the nozzles 208 and 209 for reuse.

By reusing the chemicals from the dummy dispense receptacles 210 and 211 in the manufacturing process, the embodiments described herein allow manufacturers to save substantial costs that would otherwise be incurred on wasted chemicals and higher frequency of chemical container maintenance, such as container replacement and refilling. Additionally, manufacturers may avoid the time, expense, and legal hurdles of disposing waste chemicals from the dummy dispense receptacles. These potential advantages may be realized because a single dummy dispense receptacle is dedicated to containing only a single chemical. Unlike previous methods, a dummy dispense receptacle does not contain solvents or mixtures of the different types of chemicals that cannot be reused.

A controller 221 may be used to coordinate the interaction and timing among different components in the dispensing process. The controller 221 may be, for example, a computer, with connections or other communication paths to various components in order to monitor the progress of the chemical dispensing, and to initiate, control, and/or terminate actions taken by those components. In this example, controller 221 communicates with pumps 204 and 205 to regulate the flow of chemicals 217 and 218 into the nozzles 208 and 209. Controller 221 also communicates with nozzles 208 and 209 and wafer 220 to coordinate the positioning of the nozzles 208 and 209 back and forth between the dummy dispense receptacles 210 and 211, and the surface of the wafer 220. Controller 221 may also coordinate the timing of dispensing from the nozzles 208 and 209, ensuring the appropriate dispensing over the wafer 220, and, when appropriate, ensuring that no dispensing occurs during while the nozzle is in motion. The controller 221 may further monitor the dummy dispense receptacles 210 and 211, and activate/deactivate the pumps 214 and 215 as needed to return the chemicals 217 and 218 into their respective containers 202 and 203. The controller 221 may also communicate with a device used to support and position the semiconductor wafer 220, in order to properly position the wafer 220 before and after the chemicals 217 and 218 are dispensed onto the wafer's 220 surface. For example, the controller 221 may receive a signal indicating that the semiconductor wafer 220 is ready for a coat of resist, and in response to this signal, may stop the dispensing of the resist into the dummy dispense receptacle 210, position the dispense nozzle 208 over the wafer 220, and dispense resist onto the wafer's 220 surface. Further, the controller 221 may control the spinning of the wafer 220 in order to provide a more even coating of the chemicals 217 and 218 onto the surface of the semiconductor wafer 220.

In certain embodiments, the pumps 214 and 215 may be low-accuracy pumps. In contrast to the high-accuracy pumps 204 and 205, used in some embodiments to dispense the chemicals 217 and 218 onto the surface of the wafer 220, the return of the chemicals 217 and 218 from the dummy dispense receptacles 210 and 211 to their containers 202 and 203 does not necessarily require the same degree of precision. In fact, in certain embodiments, the low-accuracy pumps 214 and 215 may include or be replaced with a gravity fed flow, a vacuum flow, or another non-powered mechanism to transport the chemicals 217 and 218 from the dummy dispense receptacles 210 and 211 into the containers 202 and 203, respectively. In yet other embodiments, the chemical containers 202 and 203 may be the same physical containers as the dummy dispense receptacles 210 and 211, respectively. In such configurations, the pumps 214 and 215 and/or their respective feedback paths may be unnecessary, as the chemicals 217 and 218 would be pumped directly out of the dummy dispense receptacles 210 and 211 with pumps 204 and 205. In other words, the containers and dummy dispense receptacles would be one in the same.

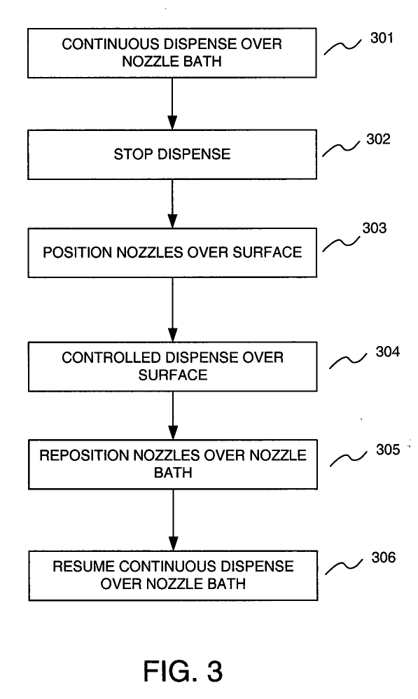

Referring to FIG. 3, a flowchart is shown demonstrating illustrative steps that may be performed during operation of the fluid dispense system of FIG. 2. The flowchart in FIG. 3 represents the activity of a single nozzle, for example 208, performing a single dispense of resist 217 over semiconductor wafer surface 220.

In step 301, the nozzle is positioned over the dummy dispense receptacle and is dispensing a continuous spray of resist or other chemical into the receptacle. Such a spray is referred to herein as a “dummy dispense,” since the chemical is being dispensed, but not over the wafer surface 220. The properties of this spray, such as the force and width of the spray, may be configured to prevent the resist from drying and forming solid particles at the tip of the nozzle. In certain embodiments, this dummy dispense spray has the same force and width as is used to dispense the fluid over the surface of the wafer 220. The height of the nozzle 208 or 209 above the “pool” of chemical 217 or 218 that accumulates in the dummy dispense receptacle 210 or 211, may be sufficiently high such that the tip of the nozzle 208 or 209 does not touch the pool of chemical 217 or 281. Submersion of the nozzle into the pool, or splash back from the pool onto the outside of the nozzle, may occur if the nozzle is positioned too close to the chemical pool or the dummy dispense spray is too forceful. Submersion of the nozzle or chemical splash back may be undesirable, since any fluid on the outside of the nozzle 208 or 209 may drip on the surface of the wafer 220 during a subsequent dispense. In certain embodiments, the height level of the current chemical pool in the dummy dispense receptacle 210 or 211 is monitored and used to control the suspended height of the nozzle 208 or 209 over the pool, or to activate the pump 214 or 215 responsible for removing the fluid 217 or 218 from the dummy dispense receptacle 210 or 211.

In step 302, the dummy dispense, which has been continuous up to this point, is stopped temporarily. This stop may be prompted by a signal received from the controller 221, indicating that the next semiconductor wafer 220 is ready, or will soon be ready, for a resist dispense from this nozzle. The dummy dispense may be stopped prior to removing the nozzle from the receptacle, e.g., as near in time as possible to the subsequent surface dispense, in order to reduce the chance of particle solidification at the nozzle tip. Then, in step 303, the nozzle is positioned over the wafer or other desired surface. This step may be performed by a mechanical arm (not shown) to which one of the nozzles is mounted. The mechanical arm move to a position near the surface so as to position the nozzle directly over the surface. Alternatively, the wafer 220 may be moved and positioned below a fixed nozzle, while the dummy dispense receptacle is also moved.

In step 304, the nozzle emits a controlled dispense of the fluid over the surface of the wafer 220, according to the specifications of the manufacturing process. For example, in a semiconductor lithography process, the semiconductor wafer 220 may be evenly coated with a layer of resist, just before the exposure of the wafer 220 to a UV light grid pattern. To aid in achieving an even coat, the wafer 220 may spin while the resist or other chemical is being dispensed.

In step 305, the nozzle is repositioned back over the dummy dispense receptacle, and in step 306 the dummy dispense spray of fluid into the dummy dispense receptacle resumes. This dummy dispense may constitute a continuous and uninterrupted spray from the nozzle into the dummy dispense receptacle, until a time just prior to the next surface dispense. Alternatively, the dummy dispense spray may be non-continuous, such as in periodic spurts. A non-continuous dummy dispense may, for example, spray once just before the nozzle is to be positioned over the surface of the wafer 220, reducing the amount of time in which the non-flowing chemical is present at the nozzle tip.

Additionally, the force of the dummy dispense spray may be controlled to reduce particle accumulation. The dummy dispense may, for example, spray with greater force than is used to dispense the chemical over the surface of the wafer 220, and may thus “blast” particles from the nozzle tip. This force may also vary periodically throughout a continuous or periodic dummy dispense, increasing and decreasing the nozzle spray force to aid in reducing particle accumulation at the nozzle tip. In any of the above-described illustrative embodiments, the dummy dispense spray may prevent the chemical from drying up and solidifying at the tip of the nozzle, thus aiding in reducing or even preventing particle accumulation in the fluid from compromising the quality of subsequent surface dispenses.

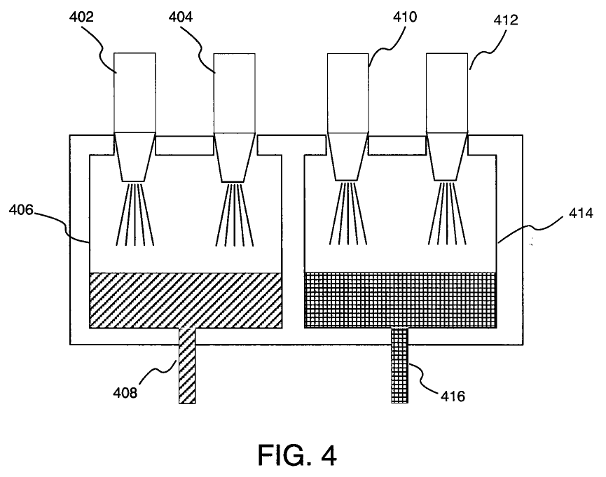

FIG. 4 shows multiple nozzle groups, each group feeding into a different dedicated dummy dispense receptacle. In this example, nozzles 402 and 404 dispense the same chemical, so they may dispense into a single dummy dispense receptacle 406 without mixing different chemicals and thereby rendering the dispensed chemicals unusable. These nozzles 402 and 404 may receive their supply of the chemical from the same chemical container, or alternatively, from different containers holding the same chemical. Similarly, nozzles 410 and 412 dispense a chemical into dummy dispense receptacle 414. In this example, nozzles 410 and 412 both dispense the same chemical, however it may be a different chemical from that dispensed by nozzles 402 and 404. Dummy dispense receptacle 414 may be separated from dummy dispense receptacle 406, so that each receptacle is dedicated to a single chemical substance. Embodiments in which a nozzle group dispenses the same chemical to a single dummy dispense receptacle may enjoy the above-described potential advantages resulting from the separation of different chemicals, while potentially providing additional cost-saving advantages to the manufacturer. Such embodiments may permit the reduction of the number of dummy dispense receptacles, drains, pumps, and other related equipment.

The contents of group dummy dispense receptacle 406 are emptied through a drain 408, and may be pumped back into a single chemical container. Similarly, the contents of the dummy dispense receptacle 414 are emptied through a drain 416, and may be pumped back into a different chemical container. Alternatively the drainage flow from either dummy dispense receptacle 406 or 414 may be split and pumped into multiple containers of the same chemical. In certain embodiments, the determination of where to pump the chemicals drained from a dummy dispense receptacle is based on the number of chemical containers, the amount remaining in each container, and the anticipated future usage of each container. For example, the controller 221 may compare the amount remaining in two different containers of the same chemical, and accordingly route the contents of the dummy dispense receptacle 406 back into the least full container. Such embodiments allow manufactures to coordinate the timing at which multiple chemical containers will become empty, and thus can schedule refilling or replacement of similar containers at the same time.

While the foregoing descriptions and the associated drawings may relate to a semiconductor lithography process, many modifications and other embodiments will come to mind to one skilled in the art having the benefit of the teachings presented. The illustrative embodiments described herein may be adaptable to any manufacturing process that requires the distribution of a fluid substance.

What is claimed is:

1. A method for dispensing lithography resist onto a semiconductor wafer, comprising:
dispensing resist from a first nozzle into a first dummy dispense receptacle;
stopping the dispensing of resist from the first nozzle into the first dummy dispense receptacle;
dispensing resist from the first nozzle onto a semiconductor wafer; and
transporting resist from the first dummy dispense receptacle along a first fluid transport path back to the first nozzle.

2. The method of claim 1, further comprising the step of positioning at least one of the first nozzle and the semiconductor wafer such that the first nozzle is over a surface of the semiconductor wafer.

3. The method of claim 1, wherein the first fluid transport path comprises at least one pump and at least one section of pipe configured to convey resist back to the first nozzle.

4. The method of claim 1, where the step of transporting resist comprises:
pumping resist with a first pump from the first dummy dispense receptacle to a resist storage container; and
pumping resist with a second pump from the resist storage container to the first nozzle.

5. The method of claim 4, wherein the pumping of resist from the resist storage container to the first nozzle occurs with higher accuracy than the pumping of resist from the first dummy dispense receptacle to the resist storage container.

6. The method of claim 1, further comprising:
dispensing ARC from a second nozzle into a second dummy dispense receptacle;
stopping the dispensing of ARC from the second nozzle into the second dummy dispense receptacle;
dispensing ARC from the second nozzle onto the semiconductor wafer; and
transporting ARC from the second dummy dispense receptacle along a second fluid transport path back to the second nozzle.

7. The method of claim 6, wherein the first dummy dispense receptacle and the second dummy dispense receptacle are separate and dedicated to their respective dispensed substances.

8. The method of claim 1, wherein the stopping of the dispensing of resist from the first nozzle into the first dummy dispense receptacle is performed in response to a signal from a controller, said signal indicating that the semiconductor wafer is ready for a coat of resists.

9. An apparatus, comprising:
a first nozzle configured to dispense resist over a semiconductor wafer;
a dummy dispense receptacle configured to collect the resist dispensed by the first nozzle; and
a fluid transport path configured to transport resist from the dummy dispense receptacle back to the first nozzle.

10. The apparatus of claim 9, wherein the fluid transport path comprises at least one pump and at least one section of pipe configured to convey resist back to the first nozzle.

11. The apparatus of claim 9, wherein the fluid transport path comprises:
a resist storage container;
a first pump configured to transport resist from the dummy dispense receptacle to a resist storage container; and
a second pump configured to transport resist from the resist storage container to the first nozzle.

12. The apparatus of claim 9, further comprising:
a controller configured to regulate the dispensing of the resist from the first nozzle and configured to regulate the position of the first nozzle relative to the semiconductor wafer.

13. The apparatus of claim 12, wherein the controller is configured to stop dispensing the resist into the dummy dispense receptacle and to position the first nozzle over a surface of the semiconductor wafer, in response to a signal indicating that the semiconductor wafer is ready for a coat of resist.

14. An apparatus, comprising:
a first nozzle configured to dispense a first fluid over a semiconductor wafer;
a first receptacle configured to collect the first fluid dispensed by the first nozzle;
a first feedback path configured to transport the first fluid from the first receptacle back to the first nozzle;
a second nozzle configured to dispense a second fluid over a semiconductor wafer;
a second receptacle configured to collect the second fluid dispensed by the second nozzle; and
a second feedback path configured to transport the second fluid from the second receptacle back to the second nozzle.

15. The apparatus of claim 14, wherein the first feedback path and the second feedback path comprise at least one pump coupled to at least one section of pipe.

16. The apparatus of claim 14, further comprising:
a first fluid storage container;
a first pump configured to transport the first fluid from the first receptacle to the first fluid storage container;
a second pump configured to transport the first fluid from the first fluid storage container to the first nozzle;
a second fluid storage container;
a third pump configured to transport the second fluid from the second receptacle to the second fluid storage container; and
a fourth pump configured to transport the second fluid from the second fluid storage container to the second nozzle.

17. The apparatus of claim 16, wherein the first fluid storage container contains resist and the second fluid storage container contains ARC.

18. The apparatus of claim 16, wherein the second pump and the fourth pump are each configured to transport fluid with higher accuracy than each of the first pump and the third pump.

19. The apparatus of claim 14, further comprising:
a controller configured to regulate the dispensing of the first fluid from the first nozzle, the dispensing of the second fluid from the second nozzle, and the relative positioning among the first nozzle, the second nozzle, and the semiconductor wafer.

20. The apparatus of claim 19, wherein the controller is configured to:
receive a signal indicating that the semiconductor wafer is ready for a coat of at least one of the first and second fluids; and
stop the dispensing of the fluid into at least one of the first and second receptacles, in response to the signal.
